(19) United States
(12) Patent Application Publication
(10) Pub. No.: US 2005/0261977 A1
(43) Pub. Date: Nov. 24, 2005

(54) Commodity rental apparatus, commodity rental system, and commodity rental method

(76) Inventors: Ryozo Kiji, Kanagawa (JP); Kimio Fujinawa, Tokyo (JP)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/486,736

(22) PCT Filed: Aug. 16, 2002
(86) PCT No.: PCT/JP02/08330

§ 371 Date: Feb. 13, 2004

(30) Foreign Application Priority Data
Aug. 16, 2001 (JP) 2001246920

(51) Int. Cl. G06F 17/60

(52) U.S. Cl. 705/26

(57) ABSTRACT

A commodity rental apparatus includes an input unit, a containing unit, and a return unit. The input unit selects a predetermined commodity and inputs commodity rental information. The containing unit has a commodity containing column having a data carrier, reads an identification number of a commodity selected by a commodity number input by a user via an antenna arranged at the column, and specifies a commodity. Furthermore, the specified commodity is carried from the containing column to the commodity pick-up unit, so that the user can picks it up. The return unit reads rental information recorded on the data carrier of the commodity returned through a return hole via an antenna arranged in the vicinity of the return hole, accepts the commodity, and contains it in a stocker to which it is conveyed by a predetermined convey mechanism.

### TECHNICAL FIELD

The present invention relates to a commodity rental apparatus with easy management and high usability, commodity rental system and commodity rental method.

### BACKGROUND ART

In recent years, there have become widespread automatic rental apparatuses or automatic vending machines for storage media such as VCT (Video Cassette Tape), CD (Compact Disk), DVD (Digital Versatile Disk) and like that record images or music information thereon. At the store where such automatic rental apparatus is installed (for example, unmanned video rental store), there is no need to station salespersons who provide service for selling or renting commodities. Accordingly, this makes it possible to save personnel costs and fix business hours arbitrarily (around-the-clock service is possible), thereby increasing merits in maintenance and management.

However, from viewpoint of users, this provides a restriction in use, resulting in a poor usability as compared with the general store such as a video rental store. For example, at the time of using the automatic rental apparatus, since a membership card, which is issued for each automatic rental apparatus, is used even at the same chain store, the membership card corresponding to each automatic rental apparatus must be used to perform rental and return at the time of using multiple automatic rental apparatuses, so that the procedure is complicated.

For this reason, Unexamined Japanese Patent Publication 10-49734 discloses an automatic rental apparatus in which an IC card is used as a user (membership) card. According to this automatic rental apparatus, since all information on the rental and return of the commodity is recorded on one IC card, even a different automatic rental apparatus is available using one IC card.

However, even in this case, since the rental commodity is managed by only the automatic rental apparatus that stores the commodity, the user must return the rent commodity to the automatic rental apparatus that provided rental service. For example, regarding the commodity, which the user rent by an automatic rental apparatus at a location where he/she went out, he/she cannot return it to an automatic rental apparatus located close to his/her house.

Moreover, stock information and rental information on the commodities in the automatic rental apparatus are stored in only the relevant automatic rental apparatus. Accordingly, for instance, in order to replenish commodities, the salesperson must go to the place where each automatic rental apparatus is installed and check individual stock information and the like, so that efficiency is poor. Moreover, when there is no stock of a desired commodity in the specific automatic rental apparatus, the user cannot grasp the stock of the desired commodity in the other automatic rental apparatus, so that he/she cannot rent the desired commodity even if he/she goes to a place where another automatic rental apparatus is installed, resulting in poor usability.

### DISCLOSURE OF INVENTION

The present invention has been made with consideration given to the aforementioned circumstances, and an object of the present invention is to provide a commodity rental apparatus with easy management and high usability and commodity rental system.

A commodity rental apparatus of the present invention comprises an input unit that selects a commodity to input rental information for renting the selected commodity, a containing unit that contains a commodity with a record tag on which identification information for identifying the commodity is recorded in advance to deliver the commodity selected by the input unit after executing reading/writing of predetermined information onto the record tag, a return unit that accepts a commodity to be returned, and reads rental information recorded on the record tag of the commodity to generate return information, and
a control unit that is connected to the input unit to control the containing unit and the return unit, wherein the control unit reads identification information recorded on the record tag based on rental information sent from the input unit, identifies the commodity to be delivered from the containing unit, records rental information on the record tag of the commodity, and records return information sent from the return unit on the record tag of the commodity when the commodity is accepted by the return unit.

According to this configuration, when rental information is recorded on the record tag of the commodity to rent the commodity and the return of the commodity is accepted, return information is generated based on rental information recorded on the record tag of the commodity, and the return information is recorded on the record tag of the commodity. This enables the user to surely return the commodity even if any commodity rental apparatus is used.

Moreover, a commodity rental apparatus of the present invention comprises input means for selecting a predetermined commodity to input rental information for renting the selected commodity, containing means, which includes a column containing a commodity with a record tag on which identification information for identifying the commodity is recorded in advance and a first reader/writer section that is wirelessly communicable with the record tag, for identifying the commodity selected by the input section based on identification information recorded on the record tag to deliver the commodity from the column after writing rental information of the commodity sent from the input means, return means, which includes a return hole through which a commodity to be returned is accepted, a stocker that contains the commodity, and a second reader/writer section that is wirelessly communicable with the record tag of the commodity, for reading rental information recorded on the record tag of the commodity to generate return information, and information management means, which is connected to the input means and the return means, for recording rental information sent from the input means to update the recorded rental information based on return information sent from the return means.

A commodity rental system of the present invention comprises a commodity rental apparatus that rents a commodity, and a management server that is connected to the commodity rental apparatus via a network, wherein the commodity rental apparatus comprises return means, which includes a return hole through which a commodity to be returned is accepted, a stocker that contains the commodity, and a second reader/writer section that is wirelessly communicable with the record tag of the commodity, for reading rental information recorded on the record tag of the commodity to generate return information, and containing means, which includes a column containing a commodity with a record tag on which identification information for identifying the commodity is recorded in advance and a first reader/writer section that is wirelessly communicable with the record tag, for identifying the commodity selected by the input section based on identification information recorded on the record tag to deliver the commodity from the column after writing rental information of the commodity sent from the input means, the commodity rental apparatus transmits identification information and rental information of the commodity to the management server when the commodity is delivered by the containing means, the management server stores rental information sent from the commodity rental apparatus to be associated with identification information, the commodity rental apparatus sends the management server sends the management server a request for rental information corresponding to the identification information of a commodity when the return means accepts the commodity, generates return information by the return means based on rental information sent from the management server in response to the request, and transmits the return information to the management server, and the management server updates rental information based on return information sent from the commodity rental apparatus.

A commodity rental method of the present invention comprises the input step of selecting a kind of a predetermined commodity with a record tag on which identification information for identifying the commodity is recorded in advance to input rental information for renting the commodity corresponding to the selected kind, the rental step of reading identification information recorded on the record tag to select a commodity corresponding to the kind of the commodity selected in the input step and record rental information of the commodity input in the input step on the record tag of the selected commodity to deliver; the rental information storage step of storing identification information and rental information of the commodity, the return step of accepting a commodity to be returned to read identification information of the commodity, the return information generation step of reading rental information corresponding to identification information of the commodity read and returned in the return step to generate return information based on the rental information; and the update step of updating rental information stored in the rental information storage step based on the return information.

### BRIEF DESCRIPTION OF THE DRAWINGS

FIG. 1 is a block diagram illustrating a configuration of a commodity rental system according to an embodiment of the present invention;

FIG. 2 is a front view of a commodity rental system according to an embodiment of the present invention;

FIG. 3 is a schematic view illustrating an outline structure of a containing unit of a commodity rental system according to an embodiment of the present invention;

FIG. 4 is a schematic view illustrating an example of rental information stored by a management server according to an embodiment of the present invention;

FIG. 5 is a flowchart illustrating a commodity rental procedure using a commodity rental system according to an embodiment of the present invention;

FIG. 6 shows an example of an initial screen of a commodity rental apparatus of a commodity rental system according to an embodiment of the present invention;

FIG. 7 shows an example of a rental information input screen of a commodity rental apparatus of a commodity rental system according to an embodiment of the present invention;

FIG. 8 is a flowchart illustrating a commodity return procedure using a commodity rental system according to an embodiment of the present invention;

FIG. 9 shows an example of a return confirmation screen of a commodity rental system according to an embodiment of the present invention;

FIG. 10 shows an example of a rental application screen of a commodity rental system according to a modification of the present invention;

FIG. 11 shows an example of a rental confirmation screen of a commodity rental system according to a modification of the present invention;

FIG. 12 is a front view of a commodity rental apparatus according to a modification of the present invention;

FIG. 13 is a schematic view illustrating an internal structure of a commodity containing unit of a commodity rental apparatus according to a modification of the present invention;

FIG. 14 is a schematic view illustrating the outline and internal structures of a return unit of a commodity rental apparatus according to a modification of the present invention; and

FIG. 15 shows another structural example of a containing unit of a commodity rental apparatus according to an embodiment of the present invention.

### BEST MODE FOR CARRYING OUT THE INVENTION

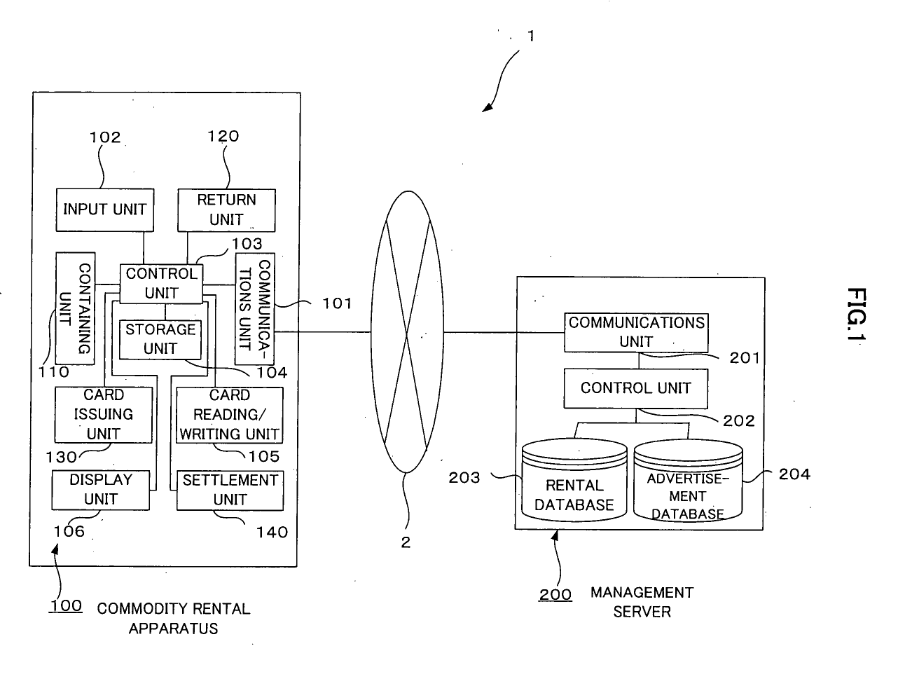

A commodity rental system and the like according to an embodiment of the present invention will be explained with reference to the attached drawings. FIG. 1 is a configuration view of a commodity rental system according to an embodiment of the present invention. A commodity rental system 1 includes a commodity rental apparatus 100 provided in, for example, a convenience store, a station, a hospital, and a management server 200 connected to the commodity rental apparatus via a network 2. A record tag, which records information for identifying each commodity and controlling it, is added to each commodity used in this system. For example, the record tag may be a read only record tag such as a barcode or one that can read and write information wirelessly such as an IC chip or ID tag. In this embodiment, the IC chip is used and information for identifying a commodity such as a commodity name, an identification number, etc. is recorded thereon in advance. Moreover, a membership card for identifying a user is used, and the membership card is an IC card to which an IC chip for recording membership information, using history for each member, and the like is added.

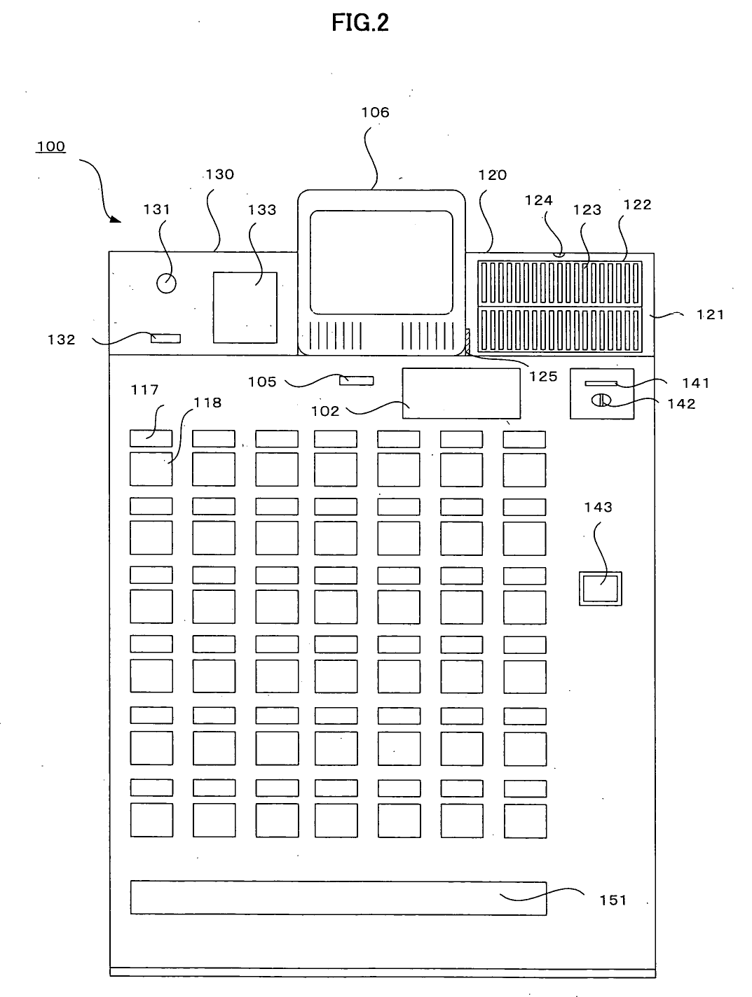

FIG. 2 is a front view illustrating one example of an outline of the commodity rental apparatus 100. The commodity rental apparatus 100 includes a communications unit 101, an input unit 102, a control unit 103, a storage unit 104, a card reading/writing unit 105, a display unit 106, a containing unit 110, a return unit 120, a card issuing unit 130, and a settlement unit 140.

The communications unit 101 includes a modulation unit, a demodulation unit, an interface unit and the like. Membership information, rental information and the like sent from the control unit 103 are modulated and transmitted to the management server 200 via the network 2. Moreover, the communications unit 101 receives rental information or commodity advertisement information sent from the management server 200, performs demodulation (including decoding processing, error correction processing, and the like) and transmits it to the control unit 103.

The input unit 102 is a touch panel having a display function for which a user selects predetermined processing (for example, rental processing) from a processing menu to input a predetermined instruction or data. In response to the user's selection, the input unit 102 transmits a signal, which requests the selected processing, to the control unit 103. In response to this, an execution screen for inputting data necessary to execute the predetermined processing sent from the control unit 103, is displayed. In response to the user's operation from the execution screen, a signal, which indicates the input instruction or data, is transmitted to the control unit 103.

The control unit 103 includes a CPU (Control Processing Unit), a ROM (Read Only Memory), a RAM (Random Access Memory) and the like. The control unit 103 stores a program for functioning as a commodity rental apparatus in the ROM and reads the program to execute. Moreover, the control unit 103 includes a predetermined oscillator and has a time function based on the oscillator.

The control unit 103 transmits a control signal that causes each of the card reading/writing unit 105, containing unit 110, return unit 120, card issuing unit 130 and settlement unit 140 to execute a predetermined processing operation.

The control unit 103 receives rental information input from the input unit 103 and records this rental information on the membership card using the card reading/writing unit 105. Moreover, the control unit 103 transmits this rental information to the management server 200. Here, rental information includes, for example, a commodity identification number, a commodity name, a membership number, a rental period (rental date, scheduled return date) and the like.

In return processing to be described later, the control unit 103 reads an identification number recorded on the membership card using the card reading/writing unit 105 in the rental processing and requests rental information, which corresponds to the identification number, of the management server 200. In response to the request, it is determined whether rental information sent from the management server 200 and read rental information match.

The control unit 103 issues/updates the membership card by the card issuing unit 130 and transmits accepted membership information (recorded on the membership card) to the management server 200 and registers it. Here, membership information includes, for example, a membership number, a password, a name, a day of birth, an address, a telephone number, and the like.

The control unit 103 detects a title of the commodity contained in the containing unit 110 and the quantity (the number of stocks), and stores it as stock management information. Moreover, when it is detected that the stock is less than a predetermined value, a warning that the rental is impossible is displayed onto the containing unit 110. Furthermore, the control unit 103 appropriately transmits this stock management information to the management server 200 together with an apparatus number that identifies the commodity rental apparatus.

The control unit 103 requests advertisement information on a specific commodity (commodity currently contained in the containing unit 110) of the management server 200 with a predetermined timing. In response to this request, advertisement information sent from the management server 200 is received and stored in the storage unit 104. This advertisement information is sequentially read and output from the display unit 106.

The storage unit 104 is a storage device including a hard disk. The storage unit 104 stores settlement information (including, for example, payment information at a rental time and adjustment information at a return time) in addition to the aforementioned stock management information and commodity advertisement information.

The card reading/writing unit 105 includes an IC reader/writer for reading data recorded on the membership card and further recording predetermined data on the membership card. The card reading/writing unit 105 records membership information, rental information, using history information (including the number of accumulative points according to the use) or reads these information items recorded thereon.

The display unit 106 is a display device including an LCD (Liquid Crystalline Display) and the like. The display unit 106 outputs commodity advertisement information received from the control unit 106.

The containing unit 110 includes selection buttons 117 for selecting each commodity and 42 pockets 118 arranged to correspond to these selection buttons and contain sample commodities as illustrated in FIG. 2, which is the front view of the commodity rental apparatus 100. In response to the user's operation, the selection button 117 generates a signal indicating that a predetermined commodity and transmits it to the control unit 103 (FIG. 1).

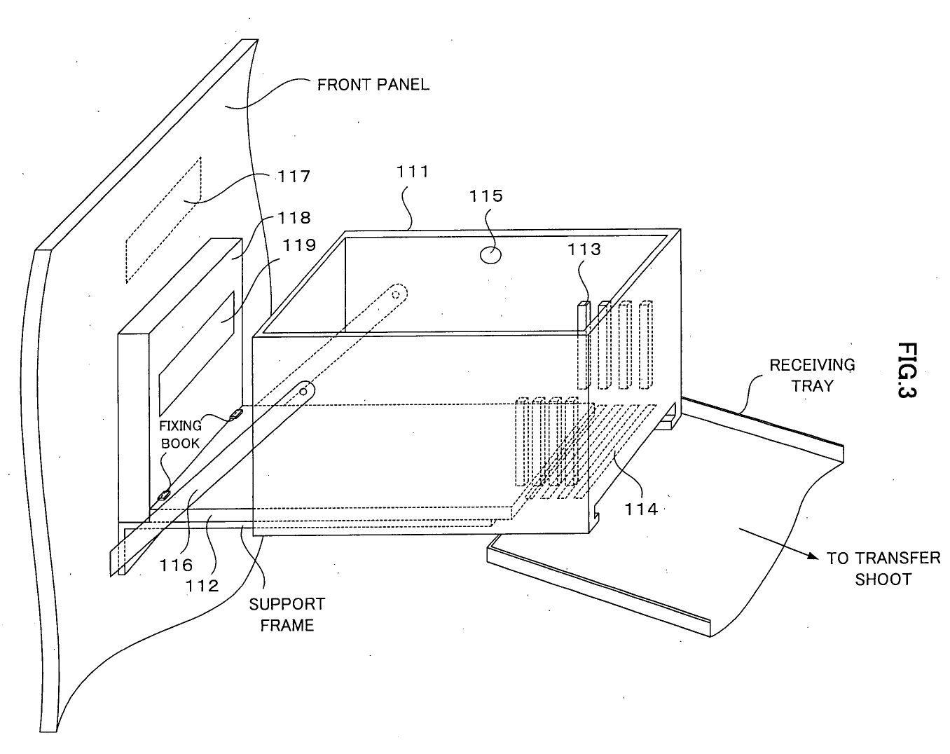

FIG. 3 shows an internal structure of the containing unit 110. 42 column main bodies 111 are used in combination with bottom plates 112 respectively as illustrated in FIG. 3. The column man body 111 has guides 113, which form divisions for containing the respective commodities in their interior, and slots 114 from which the commodities contained in the divisions are dropped into a receiving tray, respectively. Moreover, an antenna 115 for performing communications with the IC chip of the contained commodity is provided on the inner wall. The column main body 111 is driven by a movable arm 116 that is driven by a motor, and slides on the bottom plate 112 fixed to a front panel of the commodity rental apparatus 100 by a fixing hook.

The commodities are sequentially dropped into the receiving tray from the slot 114 with the slide of the column main body 114 and moved to a commodity pick-up hole 151 through a transfer shoot (not shown) connected to the receiving tray.

The containing unit 110 further includes a pocket 118 that contains a commodity sample and a reader 119 for reading information recorded on the record tag of the commodity via the antenna 115.

When the user selects rental processing from a menu displayed on the input unit 102 and operates the selection button 117 to input a predetermined rental information, the control unit 103 designates a specific column (column that contains a commodity corresponding to the kind of commodity designated by the rental information) and transmits an instruction (control signal), which sends a query radio wave to the antenna 115 of the column, to the reader 119. In response to the control signal, the reader 119 transmits the query radio wave to the commodity contained in the designated column main body 111. One commodity (commodity placed at the rightmost in FIG. 3) is identified to read an identification number of the record tag based on a response radio wave, which corresponds to the query radio wave from the record tag of each commodity.

The reader 119 produces the query radio wave to the record tag of the commodity via the antenna 115 every predetermined time and receives the response radio wave from the record tag of each commodity. The reader 119 demodulates the response radio wave and transmits it to the control unit 103. In connection with each column main body 111, the aforementioned stock management information is obtained by the control unit 103.

Here, the record tag of the commodity is a non-contact type and preferably a passive type that is operated by obtaining power from the query radio wave.

The return unit 120 includes a housing 121 made of transparent resin (for example, acrylic resin) and a return magazine (stocker) 122 as illustrated in FIG. 2. The return magazine 122 includes divisions that contain commodities (for example, 100 recording media) and slots (return holes) 123 that correspond to the respective divisions to insert the commodities at the front.

The housing 121 includes an antenna 124 for performing communications with the record tag of the commodity to be returned and a reader 125 for reading information recorded on the record tag of the commodity via the antenna 124.

When the user selects return processing from a menu displayed on the input unit 102 and returns the commodity to the return magazine 122, the control unit 103 transmits a control signal, which provides instructions to perform a read operation, to the reader 125 in response to the input. In response to the control signal, the reader 125 reads an identification number recorded on the record tag of the returned commodity, and transmits the identification number to the control unit 103.

The card issuing unit 130 includes a CCD (Charge-Coupled Device) camera 131, a card issuing hole 132, and a scanner 133.

When the user captures a front static image using the CCD camera 131 and a predetermined certification document using the scanner 133, the control unit 103 displays an input screen that requests an input of membership information on the input unit 102. In response to the user's input of membership information, the input membership information is checked with individual information included in the certification document read by the scanner 133 to determine whether these information items match. When it is determined that they match, the control unit 103 displays an input screen for registering a password as an authentication number of the user (membership card) on the input unit 102.

When the password is input by the user, the card issuing unit 130 records predetermined membership information (membership number, password, name, day of birth, address, expiration date, and the like) on the IC chip of the membership card, and imprints or prints the membership number, name, and expiration date on the membership card. The membership card is sent from the card issuing hole 132.

The settlement unit 140 includes a bill insertion slot 141, a coin insertion slot 142, and a change output hole 143 on the front surface of the commodity rental apparatus 100 and a bill/coin identifying unit and a bill/coin containing unit in its interior as illustrated in FIG. 2.

When the user inserts a predetermined amount of money into the bill insertion slot 141 or coin insertion slot 142 according to an amount of money displayed on the input unit 102, the control unit 103 identifies the inserted money using the bill/coin identifying unit to display the inserted amount of money on the input unit 102.

The management server 200 includes a communications unit 201, a control unit 202, a rental database 203, and an advertisement database 204 as illustrated in FIG. 1.

The communications unit 201 includes a modulation unit, a demodulation unit, an interface unit and the like. The communications unit 201 receives data items such as membership information, rental information, stock management information and the like that are sent from the control unit 103 of the commodity rental apparatus 100, and demodulates them and transmits them to the control unit 202.

Furthermore, in response to a request from the commodity rental apparatus 100, the communications unit 201 receives data, which includes advertisement information of the commodity searched from the advertisement database 204, from the control unit 202, demodulates them and transmits them to the commodity rental apparatus 100.

The control unit 202 includes a CPU (Central Processing Unit), a ROM (Read Only Memory), a RAM (Random Access Memory), and the like.

The control unit 202 stores membership information, rental information, and stock management information that are sent from the commodity rental apparatus 100 in the rental database 203. Moreover, in response to the request from the commodity rental apparatus 100, the control unit 202 extracts advertisement information of a specific commodity from the advertisement database 204 and transmits it to the commodity rental apparatus 100.

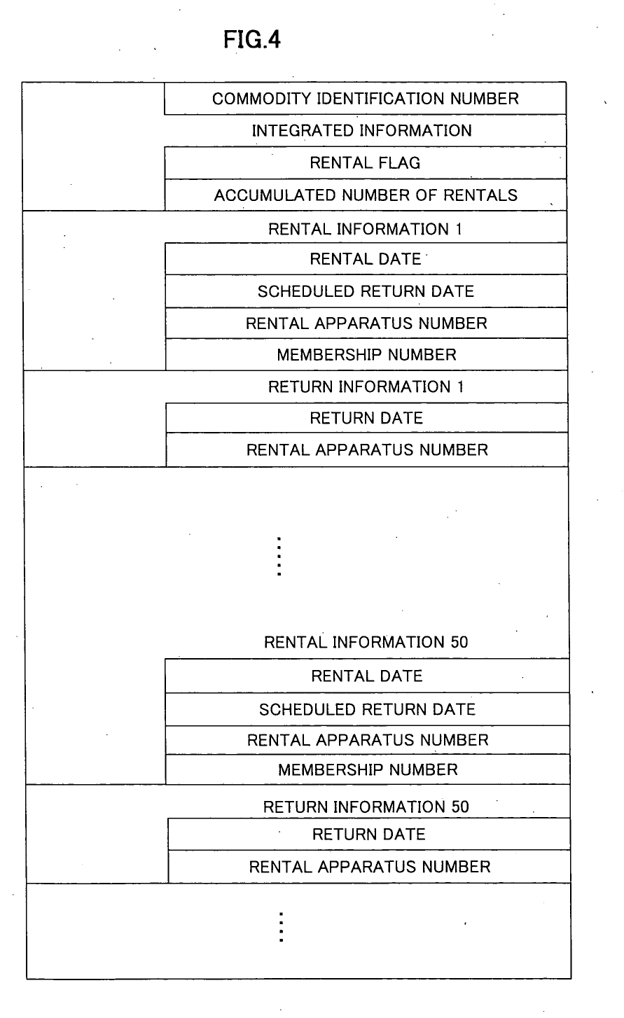

The rental database 203 stores rental information for each commodity in a format as illustrated in FIG. 4.

The advertisement database 204 stores advertisement information such as a promotion image and the like for each commodity.

An explanation will be next given of a procedure for renting a commodity using the commodity rental system in combination with the operation of each configuration component of this system.

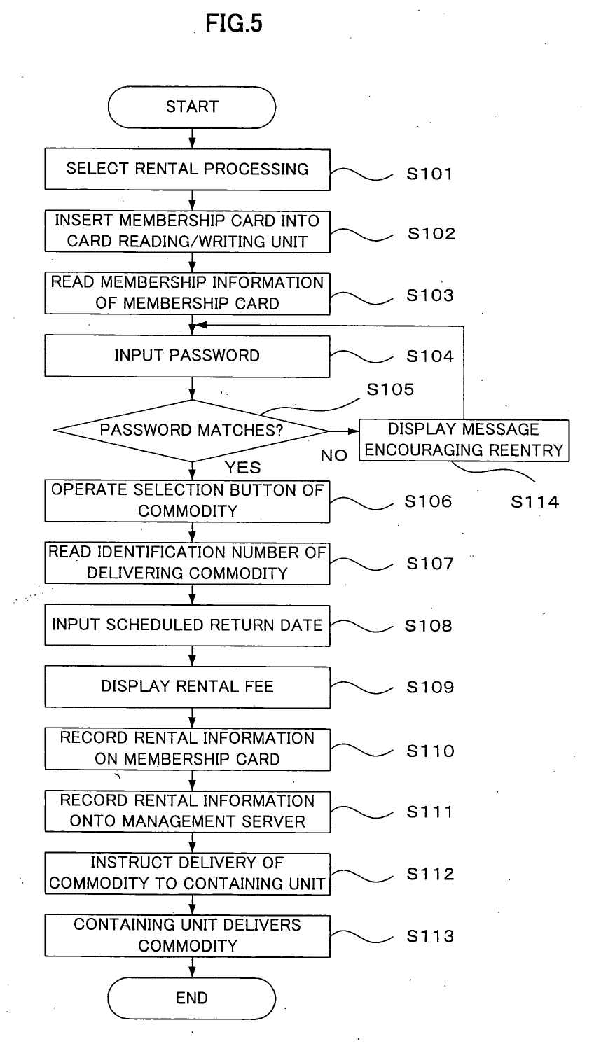

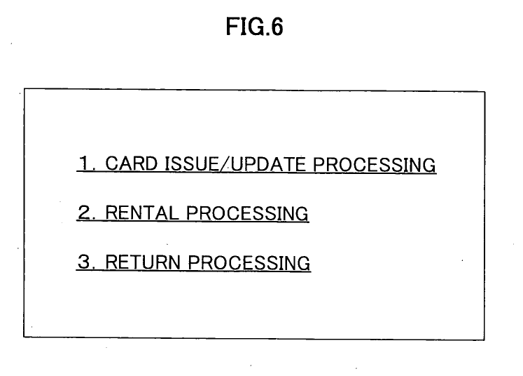

FIG. 5 is a flowchart illustrating steps of the commodity rental procedure. The user selects rental processing from an initial screen (FIG. 6) displayed on the input unit 102 (step S101). Next, the membership card is inserted into the card reading/writing unit 105 (step S102). The card reading/writing unit 105 reads membership information of the membership card and transmits the membership information to the control unit 103 (step S103).

The user inputs a password according to instructions displayed on the input screen (step S104). The control unit 103 determines whether the input password and a password included in the membership information match (step S105). When these two passwords match, the control unit 103 displays a message that instructs a next step of the rental processing.

The user decides a commodity to be rent with reference to a commodity sample of the pocket 118 of the containing unit 110 and operates the corresponding selection button 117 (step S106). In response to this operation, the control unit 103 specifies one commodity placed at a deliverable position (right end in FIG. 3) and reads an identification number of the commodity by the reader 119 via the antenna 115 arranged at the column main body 111 where the designated commodity is contained (step S107).

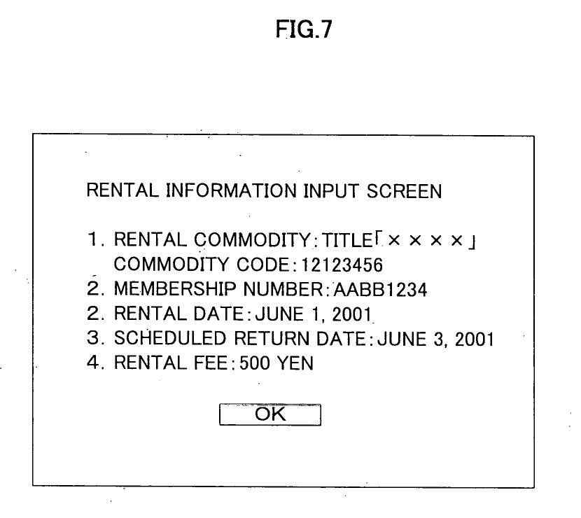

The control unit 103 displays a rental information input screen (FIG. 7) for inputting rental information on the input unit 102. On the input screen, membership information read in the step S103 and the identification number of the commodity read in the step S107 are displayed. When the user inputs a scheduled return date on the input screen (step S108), the control unit 108 requests a rental fee according to the rental period and adds it onto the input screen to display (step S109).

When the user touches an “OK” button displayed under the screen of FIG. 7 after checking the displayed contents, the control unit 103 writes rental information onto the membership card by the card reading/writing unit 105 (step S110).

The control unit 103 transmits this rental information to the management server 200. The management server 200 stores the rental information in the rental database 203 and sets a rental flag to 1 (step S111).

When the user inserts a predetermined amount of money from the bill insertion slot 141 or coin insertion slot 142, the settlement unit 140 executes settlement processing based on a rental fee displayed in step S109. The control unit 103 detects that the predetermined amount of money is input to the settlement unit 140 and transmits a control signal for delivering the commodity to the containing unit 110 (step S112). Moreover, the control unit 103 stores settlement information including a settled amount of money and settlement time in the storage unit 104.

The containing unit 110 drives a movable arm 116 in accordance with the control signal from the control unit 103 to slide the column main body 111 and deliver the commodity from the slot 114 (step S113). The delivered commodity reaches a commodity pick-up hole 151 from the receiving tray through the transfer shoot and is picked up by the user.

In step S105, when the control unit 103 determines that two passwords do not match, a message encouraging reentry is displayed on the rental information input screen since the passwords do not match (step S114). After that, the processing goes back to the step S104 and the user inputs the password again.

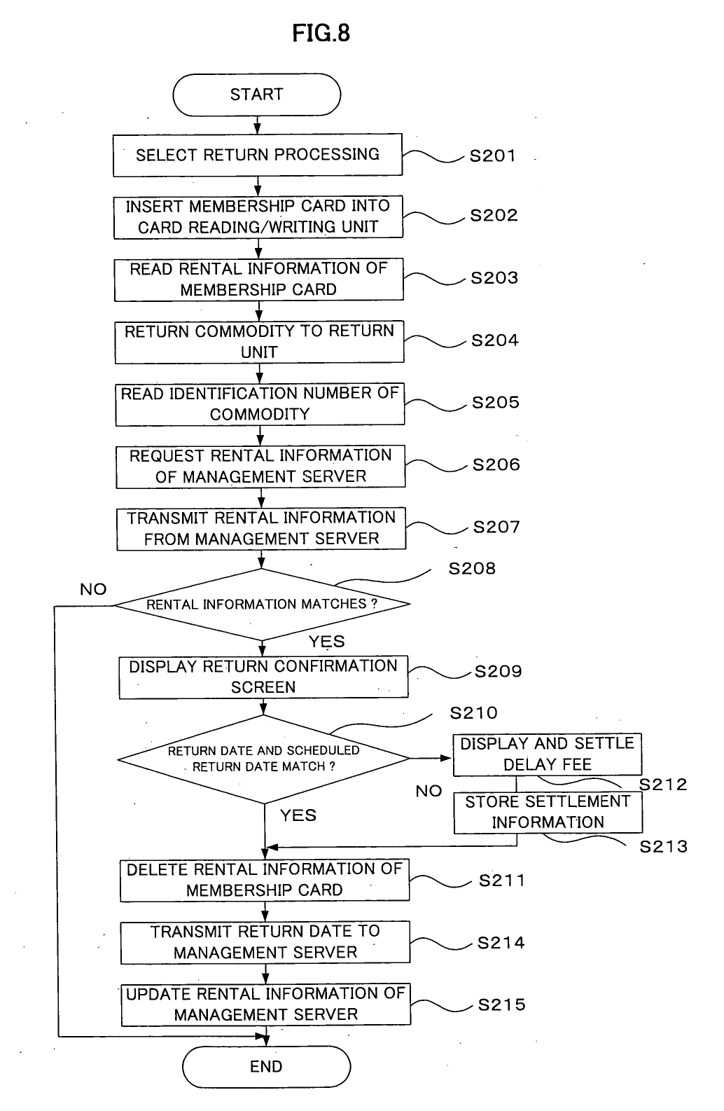

An explanation will be next given of the step of returning the rent commodity to the commodity rental apparatus with reference to FIG. 8. First of all, the user selects return processing from the initial screen of FIG. 6 displayed on the input unit 102 (step S201). Next, the membership card is inserted into the card reading/writing unit 105 (step S202). The card reading/writing unit 105 reads rental information of the membership card and transmits it to the control unit 103 (step S203).

The user inserts the commodity into the vacant division of the return magazine 122 of the return unit 120 through the slot 123 (step S204). In response to this operation, the control unit 103 reads an identification number of the inserted commodity by the reader 119 via the antenna 124 provided at the return magazine 122 (step S205).

The control unit 103 transmits a request signal, which requests return information corresponding to the identification number read in the step S205, to the management server 200 (step S206). In response to this request, the management server 200 searches the rental database 203 to extract the corresponding rental information and transmits it to the commodity rental apparatus 100 (step S207).

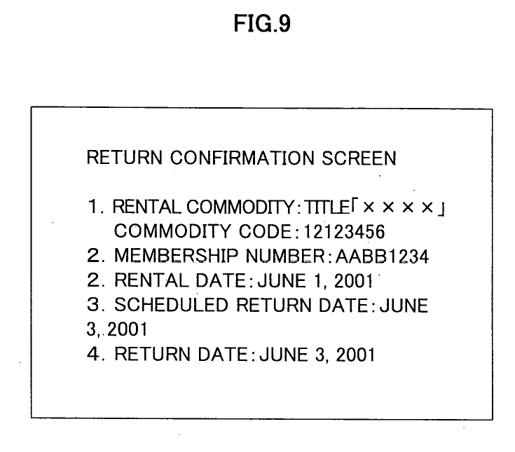

The control unit 103 receives the rental information sent from the management server 200 in step S207 and determines whether the rental information and rental information read from the member ship card in step 203 match (step S208). When these two rental information items match, the control unit 103 displays a return confirmation screen (FIG. 9) on the input screen 102 (step S209). At this time, on the return confirmation screen, an actual return date obtained by a time function of the control unit 103 is displayed.

On the other hand, when two rental information items do not match, a massage indicating this fact is displayed on the input unit 102 and the return processing ends.

Next, the control unit 103 determines whether the actual return date and the scheduled return date match (step S210). When they match (this includes a case in which the actual return date is earlier than the scheduled return date), the control unit 103 displays a message indicating that the return processing normally ends on the input unit 102 and deletes the rental information of the membership card (step S211).

On the other hand, when the actual return date is later than the scheduled return date, the control unit 103 requests a delay fee according to the delay period (difference in day between the actual return date and the scheduled return date) and displays a message indicating that the rental period exceeds and the delay fee on the input unit 102 (step S212). The control unit 103 detects that a predetermined amount of money is input to the settlement unit 140 and deletes the rental information of the membership card (step S213). Furthermore, the control unit 103 stores settlement information including the settled amount of money and the settlement time in the storage unit 104. In addition, when no money is input, the delay fee as accounts receivable is recorded on the membership card.

After that, the control unit 103 transmits the actual return date to the management server 200 (step S214). The management server 200 stores the return date sent from the commodity rental apparatus in association with the identification number and sets a rental flag corresponding thereto to 0 (step S215).

According to the present embodiment, since the management server 200 is connected to the commodity rental apparatus 100 via the network 2 and sequentially stores rental information sent from the commodity rental apparatus 100, the user may use any commodity rental apparatus when he/she returns the rent commodity.

(Modification 1)

The aforementioned embodiment explained that the commodity rental system 1 performed authentication of the user by the membership card to rent the commodity. Here, authentication and reservation may be performed by a mobile terminal that makes it possible to communicate with the management server 200 in place of the membership card.

In other words, the user gains access to a web page provided by the management server 200 from the mobile terminal, inputs an identification number of his/her mobile terminal (telephone number or terminal number and the like), name, and date of birth, and transmits them to the management server 200. In response to the user's input, the management server 200 generates a membership number, and stores the membership number, the identification number, name, and date of birth as new membership information in the rental database 203.

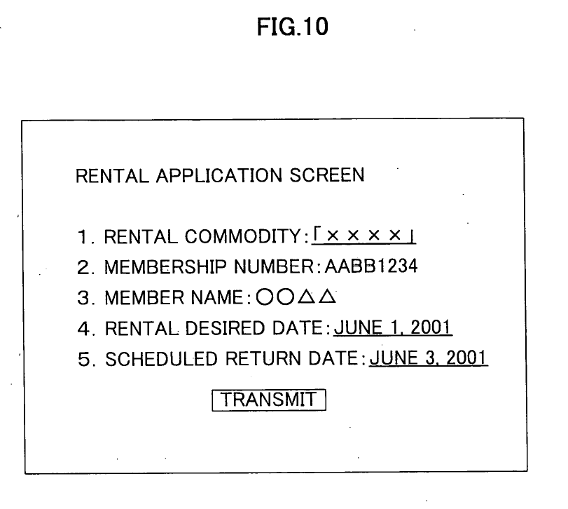

Next, the management server 200 transmits a rental application screen shown in FIG. 10 to the mobile terminal. The user displays the rental application screen sent from the management server 200 on the mobile terminal, inputs necessary items such as a commodity title, a desired rental date, a scheduled return date, and the like, and transmits them to the management server 200. The management server 200 generates rental information and a reservation number based on information sent from the mobile terminal.

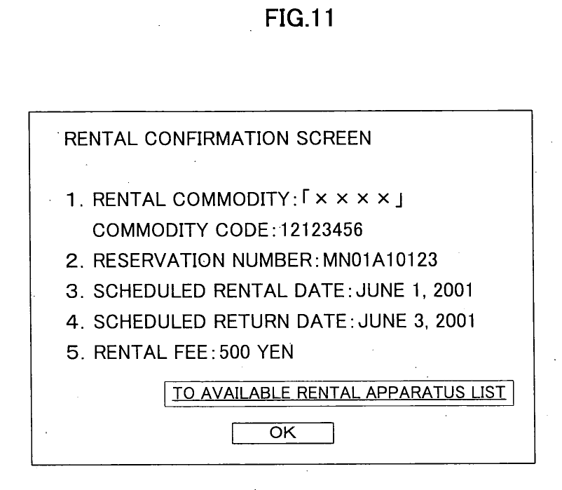

The management server 200 creates a list (including an apparatus number and an address) of the commodity rental apparatuses by which the commodity title input by the user can be rent, with reference to the stock management information of the rental database 203. The management server 200 outputs these information items as a rental confirmation screen shown in FIG. 11 to the mobile terminal. The user confirms the rental information output from the mobile terminal and clicks an “OK” button. At this time, the user checks an available commodity rental apparatus from the rental confirmation screen. In response to the user's operation, the management server 200 stores the reservation number and the rental information in the rental database 203.

The user uses the commodity rental apparatus 100 having confirmed stock of the desired commodity to display a reservation number input screen (not shown) from the initial screen of FIG. 6, and inputs the reservation number obtained in advance from the input unit 102.

In response to the input of the reservation number, the commodity rental apparatus 100 requests rental information, which corresponds to the reservation number, of the management server 200. In response to this request, the management server 200 searches the corresponding rental information from the rental database 203 and transmits it to the commodity rental apparatus 100.

The commodity rental apparatus 100 calculates a rental fee based on the rental information sent from the management server 200 and displays the rental information and the rental fee on the rental information input screen shown in FIG. 7.

When the user inserts a predetermined amount of money into the bill insertion slot 141 or coin insertion slot 142, the settlement unit 140 performs settlement processing based on the displayed rental fee. The control unit 103 detects that the predetermined amount of money is input to the settlement unit 140 and transmits a control signal for delivering the commodity to the containing unit 110. Moreover, the control unit 103 stores settlement information including a settled amount of money and settlement time in the storage unit 104.

The containing unit 110 drives the movable arm 116 in accordance with the control signal from the control unit 103 to slide the column main body 111 and deliver the commodity from the slot 114. The delivered commodity reaches the commodity pick-up hole 151 from the receiving tray through the transfer shoot and is picked up by the user.

In this way, even if the membership card is not used, it is possible to authenticate the user by use of the user's terminal that makes it possible to communicate with the management server 200. Furthermore, this is convenient since the user can reserve a desired commodity to be rent from the mobile terminal. Moreover, the terminal to be used is not limited to the mobile terminal if it is one that can communicate with the management server 200 and identify the terminal and PC and the like may be possible. In this case, a subscriber number of a provider to which the user subscribes can be used as an identification number.

The aforementioned modification explained that the user reserved the commodity from the mobile terminal. However, it is possible to settle the rental fee of the reserved commodity. For example, the user may select a cash settlement (payment in cash by the commodity rental apparatus) or credit settlement (settlement by a credit card and the like or payment from a bank account by the mobile terminal).

(Modification 2)

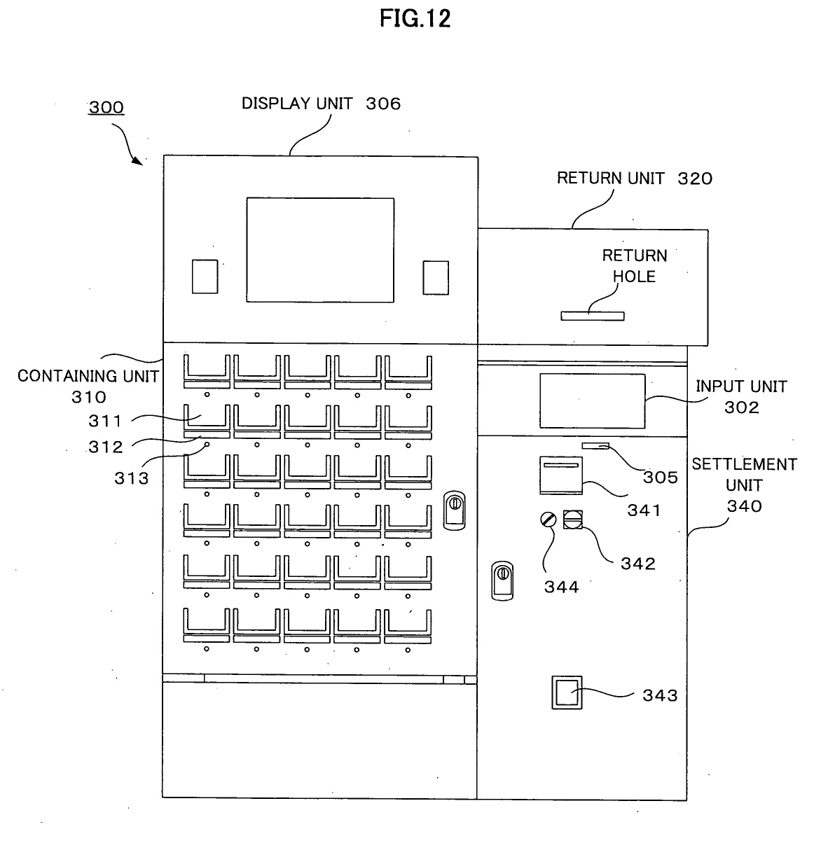

In place of the commodity rental apparatus 100 illustrated in FIG. 2, a commodity rental apparatus 300 illustrated in FIG. 12 can be used. The commodity rental apparatus 300 includes the same configurations as the apparatus 100 except for the point in which the card issuing unit and the card processing are not provided. Accordingly, except for the point in which the commodity rental apparatus 300 is used without using the membership card, both the procedure for using the commodity rental apparatus explained in the embodiment of the present invention and the operation of each configuration unit of the commodity rental apparatus are substantially the same.

However, the outline of the commodity rental apparatus 300 shown in FIG. 12 is slightly different from the apparatus 100 shown in FIG. 2 and the structure has the configuration units different from the apparatus 100. Therefore, as compared with the apparatus 100, the configuration units of the commodity rental apparatus 300 having the different structure and the operations will be explained as follows.

In this modification, the containing unit 310 includes 30 commodity containing units. As illustrated in FIG. 12, each commodity containing unit has a commodity advertisement panel 311, a commodity pick-up unit 312, and an LED display unit 313 on the front surface of the apparatus. The commodity advertisement panel 311 displays advertisement information of the commodity contained in each containing column. The commodity pick-up unit 312 discharges a commodity selected by the user according to instructions from the control unit. Moreover, the LED display unit 313 turns on when the presence or absence of the commodities contained in the containing column is detected by a reader to be described later and there is no stock of commodities.

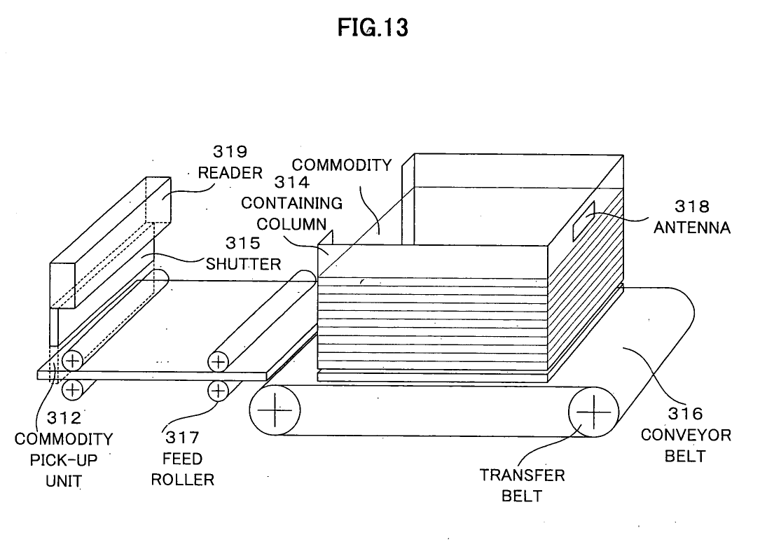

FIG. 13 is a view illustrating an internal structure of one commodity containing unit of the containing unit 310. Each containing unit includes a containing column 314, a shutter 315, a conveyor belt 316, a feed roller 317, an antenna 318, and a reader 319 in its interior.

When the user selects rental processing from a menu displayed on the input unit 302 to input predetermined rental information including the selection of the commodity, the containing column 314 corresponding to the commodity selected by the user mounts the commodity on the conveyor belt 316 by a mounting mechanism (not shown). The conveyor belt 316 is driven by the transfer roller to the mounted commodity to the feed roller 317. Here, the commodity is detected by a detection sensor (not shown) and the shutter is opened. Next, the feed roller transfers the commodity to a predetermined position of the commodity pick-up unit 312. This enables the user to pick up the commodity from the commodity pick-up unit 312. At this time, when the shutter 315 opens for more than a predetermined time, detection is executed by a predetermined sensor, so that an alarm for preventing the commodity from being forgotten to pick up operates to urge the user to use caution.

The antenna 318 is one that is used to perform communication with the record tag of the commodity and is placed on an inner wall of the containing column 314. The reader 319 is placed at the inner side of the apparatus opposing to the containing column 314 of each commodity containing unit. The reader 319 produces a query radio wave to the record tag of the commodity via the antenna 318 every predetermined time and receives a response radio wave from the record tag of the commodity in the containing column 314. The reader 319 demodulates the response radio wave and transmits it to the control unit. By the control unit, stock management information explained in the embodiment of the present invention is obtained. Moreover, when there is no stock of commodities, the LED display unit 313 on the front surface of the apparatus turns on as mentioned above according to instructions from the control unit.

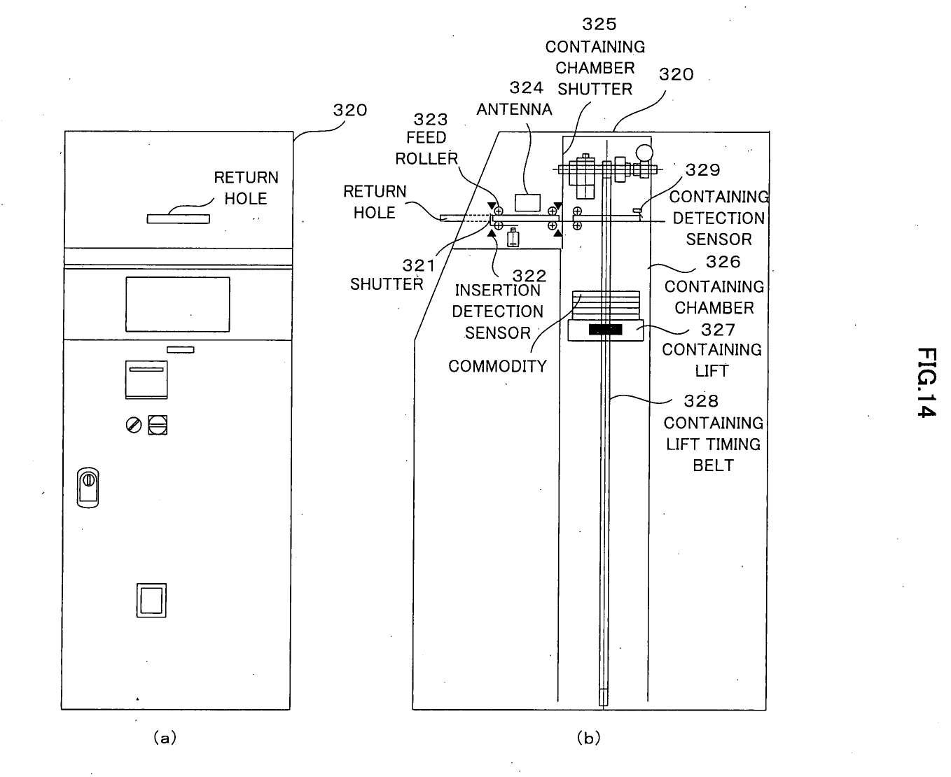

A customer unit includes a return unit 320, an input unit 302, a human detection sensor unit 305, and a settlement unit 340. When the user comes close to the customer unit, the human detection sensor 305 detects the user, so that the input unit 302 is activated to display an initial menu. An apparatus front view of the customer unit and an apparatus side view, which illustrates an internal structure of the return unit 320, are shown by FIGS. 14(a) and 14(b), respectively.

The return unit 320 includes a shutter 321, an insertion detection sensor 322, a feed roller 323, an antenna 324, a containing chamber shutter 325, a containing chamber (stocker) 326, a containing lift 327, a containing lift timing belt 328, and a containing detection sensor 329.

When the user selects return processing from the menu displayed on the input unit 302, the shutter 321 opens to accept the return of the commodity. After that, when the commodity is inserted up to a predetermined position, the insertion detection sensor 322 detects the commodity and the feed roller 323 transfers the commodity up to a predetermined position. At this time, when the control unit reads information recorded on the record tag of the returned commodity via the antenna 324 and it matches return information, the containing chamber shutter 325 opens and the commodity is conveyed by the feed roller 323 until the containing detection sensor 329 detects. In addition, an identification number included in the read information is transmitted to the control unit via the antenna 324.

When the containing detection sensor 329 detects the returned commodity, the containing lift timing belt 328 is driven by a driving unit (not shown), so that the containing lift 327 rises up to a predetermined height (position). Next, the commodity is mounted on the containing lift 327 by a mounting mechanism (not shown). When the commodity is mounted on the containing lift 327, the containing lift timing belt 328 is driven again to move down the containing lift 327 to a predetermined height (position) according to the number of mounted commodities. In this modification, the containing chamber 326 has a space that can contain 145 commodities and the containing lift 327 has a load carrying capacity that can also load 145 commodities.

When information, which is read via the antenna 324 and recorded on the record tag of the returned commodity, matches return information, the feed roller 323 reversely rotates to transfer the commodity to the return hole in an opposite direction.

Referring to FIG. 12 again, the settlement unit 340 includes a print paper issuing unit 341, a coin insertion slot 342, a coin return hole 342, and a return lever 344 on the front surface of the apparatus. The user can appropriately print necessary screen information among information displayed on the screen of the input unit 302 (touch panel) from the print paper issuing unit 341 at the time of rental processing and return processing.

In this modification, it is assumed that an ID number is provided to a membership in advance and that the ID number and a password are stored in the management server in association with each other together with predetermined membership information. In the flowchart illustrating the commodity rental procedure of FIG. 5, the user inputs his/her ID number to the input unit 302 instead of inserting the membership card into the card reading/writing unit. In response to this, the control unit of the commodity rental apparatus 300 inquires of the management sever 200 about the password corresponding to the input ID number and stores it to the storage unit upon reception of a notice of the password from the management server 200 (step S103). Sequentially, the user inputs the password according to instructions displayed on the input screen in step S104. The control unit determines whether the input password matches the password stored in the storage unit (step S105). When these two passwords match, the control unit displays a message instructing a next step of the rental processing. Afterward, steps up to steps S109 shown in FIG. 5 are executed. In step S110, the rental information is recorded on the record tag of the commodity instead of recording the rental information on the membership card.

Additionally, it is assumed that the user inputs a desired commodity number from the touch panel of the input unit 302 to select the commodity. Accordingly, in this modification, “the input of a desired commodity number from the input unit” is executed instead of executing “the operation of the selection button of commodity” in step S106 of FIG. 5 explained in the aforementioned embodiment.

Furthermore, similarly, in the commodity return step, in a case where the membership card is not used, the procedure is partially different. In a flowchart illustrating a commodity return procedure of FIG. 8, only different steps are explained. First of all, in step S202, the user inputs his/her ID number and password from the input unit 302 instead of inserting the membership card into the card reading/writing unit. In response to this, the control unit of the commodity rental apparatus 300 inquires of the management server 200 about the password corresponding to the input ID number and receives a notice of the password from the management server 200. The control unit determines whether the input password and the notified password match (step S203). When these two passwords match, the control unit displays a message that instructs a next step of the rental processing. Next, the control unit reads the rental information and identification number of the commodity returned to the return unit 320 in step S204. Sequentially, in step S208, the control unit determines whether the rental information sent from the management server 200 matches the rental information read from the record tag of the commodity in step S204. Moreover, in step S211, the return information is recorded on the record tag of the commodity instead of deleting the rental information of the membership card.

In addition, the card issuing unit and the card reading/writing unit are not limited to the structure of the commodity rental apparatus 100 and they may be added to the commodity rental apparatus 300. Modification 2 aims at only the use of the commodity rental apparatus 300 as an example in order to explain the operations of the commodity rental apparatus using no membership card and the commodity rental system.

The present invention is not limited to the aforementioned embodiment and modifications, and the application and modification are arbitrarily possible. For example, the commodity rental apparatuses 100 and 300 are not limited to the rental of commodities and they may be used to sell the commodities. Moreover, through it was explained that the number of containing units was one in the commodity rental apparatuses 100 and 300, combinations of multiple containing units can be used. Furthermore, it was explained that the commodity rental apparatus 100 had 42 commodity containing units and the commodity rental apparatus 300 had 30 commodity containing units. However, the number of commodity containing units, which the containing unit includes, is not limited to these and it is arbitrary.

The aforementioned embodiment explained the commodity rental system 1 where the commodity rental apparatus 100 was connected to the management server 200. However, the commodity rental apparatus 100 can be used in stand-alone form. In this case, the reader 119 of the containing unit 110 of the commodity rental apparatus 100 and the reader 125 of the return unit 120 are replaced with a reader/writer, respectively. Moreover, the rental information may be recorded on the record tag (IC chip) of the commodity. This enables the user to return the rent commodity even if any commodity rental apparatus 100 is used.

Though the aforementioned embodiment explained the case of renting one commodity, the number of rentable commodities is arbitrary and no limitation is imposed thereon. For example, in step S106, the user operates multiple selection buttons corresponding to the commodity to be rent. In response to this operation, the commodity rental apparatus 100 may execute steps S107 to S108 by a predetermined number of times to be associated with the number of selected commodities. However, the upper limitation of rentable commodities (for example, balance of rental is within 5 for each user) is provided to make it possible to prevent the rental of the commodities exceeding the upper limitation.

The aforementioned embodiment explained that the control unit 103 calculated the rental period based on the scheduled return date input in step S108. Here, when the rental date is the same as the scheduled return date input in step S108 on the rental information input screen shown in FIG. 7, a scheduled return time is further input and the control unit 103 may calculate a rental hour from the rental time and the scheduled return time, and execute “time rental” after calculating a rental fee based on the rental hour to display in step S109.

The aforementioned embodiment explained that the commodity rental apparatus 100 executes the settlement processing according to the amount of money input by the user. However, this settlement processing may include an account-receivable account and a deposit account. For example, when the amount of money input by the user is smaller than the delay amount, the return of commodity is normally executed and the balance is recorded on the membership card as an account-receivable account, and settlement including the balance may be executed at a next using time. Moreover, when the amount of money input by the user is larger than the rental fee, for example, the commodity rental apparatus 100 may record the balance on the membership card as a deposit account by the user's selection instead of performing the settlement processing on the spot and the user may appropriate the deposit account for the payment of the rental fee at a next using time.

The aforementioned embodiment explained that the user paid the rental fee in cash and the commodity rental apparatus 100 had the settlement unit 140 dealing with this. However, the settlement method may be one other than cash, and, for example, a method that uses the membership card having a prepaid function may be used. When the user inputs a predetermined amount of money to the settlement unit 140 at a membership card issuing time, the control unit 103 records a deposit amount on the membership card according to the input amount of money. At the using time, the rental fee may be deducted from the deposit amount. When the user runs out of the deposit amount, he/she can newly set a deposit amount by card update processing.

Though the containing state of the commodity in the containing unit 110 explained in the aforementioned embodiment is arbitrary, a cover for absorbing impact or preventing breakage may be used as required in order to prevent breakage caused by impact added due to the drop of commodity.

The aforementioned embodiment explained that the management server 200 stored stock management information sent from each commodity rental apparatus 100 in the rental database 203. The management server 200 may manage a suitable total stock of each commodity rental apparatus 100 based on the stock management information. For example, the management server 200 groups the stock management information of multiple commodity rental apparatuses existing in a predetermined area. The management server 200 calculates variations in stock within a predetermined period of time based on the grouped stock management information and decides procurement of commodities from the outside of the necessary group (or supply of commodities to the outside of the group) in order to compensate for the calculated variations in stock. Moreover, the management server 200 calculates a suitable total stock for each commodity rental apparatus in the group and decides an amount of movement (supply) of commodity between the commodity rental apparatuses in order to realize the suitable total stock.

The aforementioned embodiment explained that the containing unit 110 of the commodity rental apparatus included the column main body 111 driven by the movable arm 116 connected to the motor and the bottom plate 112 as illustrated in FIG. 3. However, the structure of the containing unit 110 is not limited to the structure of FIG. 3. Any structure may be possible if the structure can contain the commodities with a predetermined shape and deliver the commodities one by one.

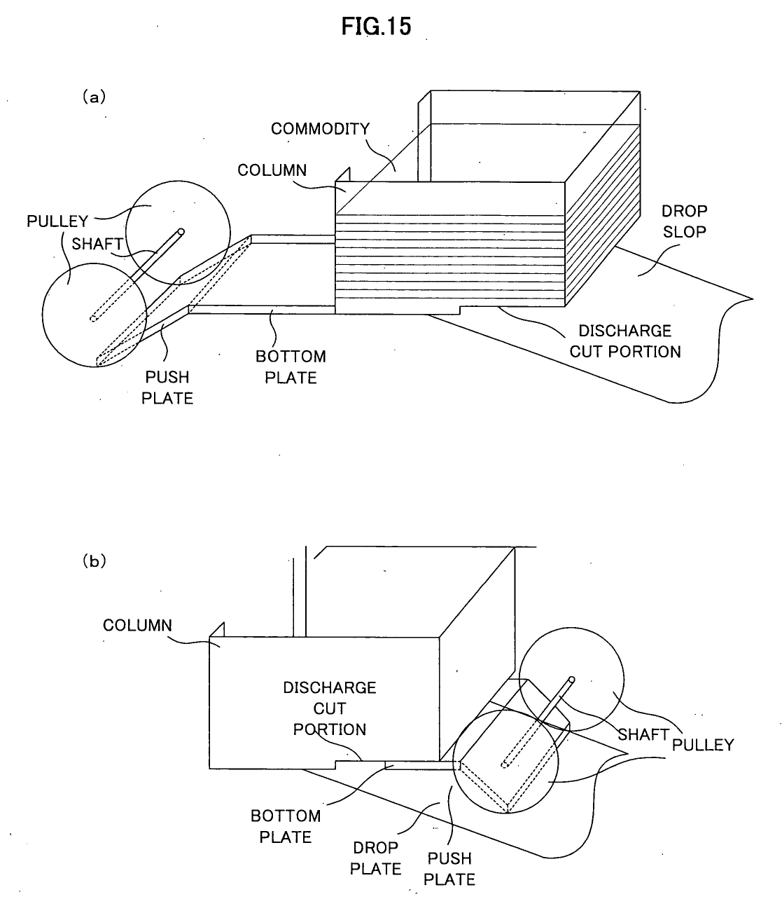

For example, as illustrated in FIG. 15(a), it includes a bottom plate, a column, a push plate, and pulleys. The bottom plate is coupled to the push plate and a front end, and sides on the bottom portion of the column with movement of the push plate. The column contains a predetermined amount of commodities in a state that they are mounted thereon. One end of the push plate is rotatably coupled to the bottom plate and the other end is fixed to a peripheral portion of a pair of the pulleys. The pulleys are attached to be rotatable around a shaft and driven by a motor (not shown).

The push plate whose other end is fixed to the pulleys moves right and left as rotating with the rotation of the pulleys (in FIG. 15(a)) and the bottom plate moves right and left with the movement. When the bottom plate moves left, the commodity of the lowest portion among the mounted commodities is delivered to a drop slope from a cut portion formed on the column.

Here, since the size of the commodity contained in the column is not constant, an adjuster member, which corresponds to the size of the containing commodity, is attached to a column interior. Moreover, the push plate and pulleys may be arranged at the rear end of the bottom plate as illustrated in FIG. 15(b).

The aforementioned embodiment explained that whether the rental information of the membership card read in step S203 matches the rental information, which was transmitted from the management server 200 in step S207 and corresponded to the identification number of the returned commodity, was determined in step S208, and that when these two rental information items did not match, the rental processing ended. However, for example, when the user, who is a member, erroneously returns the rental commodity of the other store, the returned commodity stays being contained in the return unit 120, resulting in inconvenience. For example, a reject mechanism and an operation button for starting the reject mechanism are provided at the return unit 120. When the user erroneously inserts the rental commodity of the other store into the return unit 120, the user may start the reject mechanism by the operation button to pick up the inserted commodity.

Or, when the control unit 103 of the commodity rental apparatus 100 reads the identification number of the commodity inserted into the return unit 120 in step S205 and cannot read the identification number, the reject mechanism may be operated to return the inserted commodity to the user.

The aforementioned embodiment explained that the non-contact type IC chip using radio was employed as a record tag. However, any element may be possible if it is radio communicable and information recordable, and for example, an element, which is compatible with a short distance radio communication system such as Bluetooth and the like, may be used. Moreover, the shape of the record tag is arbitrary and can be selected according to the commodity.

One skilled in the art will recognize that the present invention can be executed by those except the preferred embodiment expressed in this explanation that is not a restrictive purpose but an illustrative purpose and that the present invention is restricted by only the claims. It is described in particular that the present invention can be executed similarly in equivalence of the specific embodiment discussed in this explanation.

Priority of the present invention is claimed based on the pending Japanese Patent Application No. 2001-246920 filed on Aug. 16, 2001, entire content of which is expressly incorporated by reference herein.

### INDUSTRIAL APPLICABILITY

According to the present invention, it is possible to provide a commodity rental apparatus and commodity rental system with easy management and high usability.

1. A commodity rental apparatus comprising:
an input unit that selects a commodity to input rental information for renting the selected commodity;
a containing unit that contains a commodity with a record tag on which identification information for identifying the commodity is recorded in advance to deliver the commodity selected by the input unit after executing reading/writing of predetermined information onto the record tag;
a return unit that accepts a commodity to be returned, and reads rental information recorded on the record tag of the commodity to generate return information; and
a control unit that is connected to the input unit to control the containing unit and the return unit, wherein the control unit reads identification information recorded on the record tag based on rental information sent from the input unit, identifies the commodity to be delivered from the containing unit, records rental information on the record tag of the commodity, and records return information sent from the return unit on the record tag of the commodity when the commodity is accepted by the return unit.

2. The commodity rental apparatus according to claim 1, further comprising a card processing unit that executes reading/writing of predetermined information onto a membership card, wherein the control unit is connected to the card processing unit, records rental information on the membership card at the time of delivering the commodity from the containing unit, and updates rental information of the membership card based on return information sent from the return unit when the commodity is accepted by the return unit.

3. A commodity rental apparatus comprising:
input means for selecting a predetermined commodity to input rental information for renting the selected commodity;
containing means, which includes a column containing a commodity with a record tag on which identification information for identifying the commodity is recorded in advance and a first reader/writer section that is wirelessly communicable with the record tag, for identifying the commodity selected by the input section based on identification information recorded on the record tag to deliver the commodity from the column after writing rental information of the commodity sent from the input means;
return means, which includes a return hole through which a commodity to be returned is accepted, a stocker that contains the commodity, and a second reader/writer section that is wirelessly communicable with the record tag of the commodity, for reading rental information recorded on the record tag of the commodity to generate return information; and
information management means, which is connected to the input means and the return means, for recording rental information sent from the input means to update the recorded rental information based on return information sent from the return means.

4. The commodity rental apparatus according to claim 3, wherein the first reader/writer section and the second reader/writer section read information recorded on the record tag via antennas respectively arranged in the vicinity of the column and the return hole, and produce a radio wave for recording predetermined information on the record tag.

5. The commodity rental apparatus according to claim 4, further comprising:
storage means for storing stock information for each commodity; and
stock management means for detecting a response radio wave from each record tag of the commodities contained in the column using the first recorder/writer section to read identification information of the commodities to obtain the number of stocks according to the kind of commodity to generate stock information, and store the stock information by the storage means.

6. A commodity rental system comprising:
a commodity rental apparatus that rents a commodity; and
a management server that is connected to the commodity rental apparatus via a network, wherein the commodity rental apparatus comprises return means, which includes a return hole through which a commodity to be returned is accepted, a stocker that contains the commodity, and a second reader/writer section that is wirelessly communicable with the record tag of the commodity, for reading rental information recorded on the record tag of the commodity to generate return information, and containing means, which includes a column containing a commodity with a record tag on which identification information for identifying the commodity is recorded in advance and a first reader/writer section that is wirelessly communicable with the record tag, for identifying the commodity selected by the input section based on identification information recorded on the record tag to deliver the commodity from the column after writing rental information of the commodity sent from the input means, the commodity rental apparatus transmits identification information and rental information of the commodity to the management server when the commodity is delivered by the containing means, the management server stores rental information sent from the commodity rental apparatus to be associated with identification information, the commodity rental apparatus sends the management server sends the management server a request for rental information corresponding to the identification information of a commodity when the return means accepts the commodity, generates return information by the return means based on rental information sent from the management server in response to the request, and transmits the return information to the management server, and the management server updates rental information based on return information sent from the commodity rental apparatus.

7. The commodity rental system according to claim 6, wherein the management server is communicable with a terminal via the network, when receiving a commodity name indicating a predetermined commodity and rental information of the commodity, the management server generates a reservation number, stores rental information to be associated with the reservation number, and transmits the reservation number to the terminal, and when the reservation number is input by the input means, the commodity rental apparatus sends the management server a request for rental information corresponding to the reservation number, and selects the commodity to deliver by the containing means based on rental information sent from the management server in response to the request.

8. The commodity rental system according to claim 6, wherein the management server further comprises an advertisement database that stores advertisement information of the commodity, the commodity rental apparatus further comprises display means for outputting advertisement information, and requests advertisement information of the commodity of the management server with a predetermined timing, the management server extracts the advertisement information of a predetermined commodity from the advertisement database in response to the request and transmits it to the commodity rental apparatus, and the commodity rental apparatus receives advertisement information sent from the management server and output it by the display means.

9. A commodity rental method comprising:
the input step of selecting a kind of a predetermined commodity with a record tag on which identification information for identifying the commodity is recorded in advance to input rental information for renting the commodity corresponding to the selected kind;
the rental step of reading identification information recorded on the record tag to select a commodity corresponding to the kind of the commodity selected in the input step and record rental information of the commodity input in the input step on the record tag of the selected commodity to deliver;
the rental information storage step of storing identification information and rental information of the commodity;
the return step of accepting a commodity to be returned to read identification information of the commodity;
the return information generation step of reading rental information corresponding to identification information of the commodity read and returned in the return step to generate return information based on the rental information; and
the update step of updating rental information stored in the rental information storage step based on the return information.

10. A computer program product that records a computer program on a computer-readable storage medium, the computer program functioning as:
means for detecting the kind of commodity and the number of commodities with a record tag on which identification information for identifying the commodity is recorded based on the identification information;
means for reading identification information recorded on the tag record based on rental information input by a user to select one commodity of a kind corresponding to rent information and record rental information on the record tag of the commodity;
means for recording rental information on a membership card;
means for accepting a commodity to be returned to read rental information recorded on the record tag of the commodity and generate return information based on the rental information; and
means for updating the rental information of the membership card based on the return information to record the return information on the record tag of the accepted commodity.
